(19) United States
(12) Patent Application Publication
(10) Pub. No.: US 2013/0212041 A1
(43) Pub. Date: Aug. 15, 2013

(54) METHOD OF CONSTRUCTING STABILITY INDEXES

(71) Applicant: Frank Russell Company, (US)

(72) Inventors: Barry E. Feldman, Olalla, WA (US); David Lynn Hintz, Enumclaw, WA (US)

(73) Assignee: Frank Russell Company, Seattle, WA (US)

(21) Appl. No.: 13/712,613

(22) Filed: Dec. 12, 2012

Related U.S. Application Data
(60) Provisional application No. 61/570,238, filed on Dec. 13, 2011.

(51) Int. Cl. G06Q 40/06

(52) U.S. Cl. CPC G06Q 40/06
USPC 705/36 R

(57) ABSTRACT

Methods of constructing a stability style index from a parent index comprising assets performed by one or more computing devices. A score is assigned to each of one or more stability variables for each asset based at least in part on a value of the stability variable. A quality score is assigned to each asset based at least in part on the score assigned to each stability variable for the asset. A score is assigned to each of one or more volatility variables for each asset based at least in part on a value of the volatility variable. A volatility score is assigned to each asset based at least in part on the score assigned to each volatility variable for the asset. A probability score is assigned to each asset as a function of the quality and volatility scores. The probability scores are used to construct the stability style index.

### BACKGROUND OF THE INVENTION

1. Field of the Invention

The present invention is directed generally to methods of constructing indexes.

2. Description of the Related Art

Stock market indexes are intended to represent an entire stock market or a portion of it and thus track changes in the market or a portion thereof over time. One purpose of an index is to serve as a performance benchmark. It may be used to measure an actively traded investment portfolio's exposure and performance relative to a market opportunity set. Each index can have its own calculation methodology and is usually expressed in terms of a change from a base value. Thus, the percentage change is more important than the actual numeric value.

Indexes are created using various aggregations of securities. For example, some market indexes are intended to represent an entire stock market of a country or region and thus may be used to track changes in that market over time. Other indexes may include only securities of a particular type, securities issued by companies of a certain level of company total market capitalization (referred to as “market cap”), securities issued by companies within a particular industry, securities issued by companies belonging to a particular classification (e.g., growth stocks or value stocks), and so forth.

Market cap indexes may be created by categorizing each asset in a single pool of assets (e.g., the assets of an index such as the Russell 1000®) based on its market cap. For example, the assets may be categorized as “small cap” or “large cap.” Then, a small cap index may be created from the assets categorized as “small cap.” Similarly, a large cap index may be created from the assets categorized as “large cap.” Such indexes are sometimes referred to as “size indexes.”

Indexes can also be created to provide a benchmark for a particular investment style or strategy. For example, traditional style indexes are created based on stock valuation and include growth and value style indexes. Style indexes provide benchmarks for actively managed funds that implement the style represented by the index. To create growth and value style indexes, each asset in a single pool of assets (e.g., the assets of an index such as the Russell 1000) may be assigned a growth style score (or probability or weight) that is a measure of the stock's growth characteristics and a value style score (or probability or weight) that is a measure of the stock's value characteristics. Each stock is fully represented by the combination of the growth and value style scores, which (depending upon the implementation details) may sum to one or 100%. For example, a stock assigned a value style score of 20% has a growth style score of 80%. Then, the growth and value style scores are used to divide the stocks into growth and value style indexes.

The growth and value style indexes may be further divided based on market cap. Thus, a large cap growth style index, a small cap growth style index, a large cap value style index, and a small cap value style index may be created. Referring to FIG. 1, these divisions of the pool of assets may be illustrated as a square 10 (referred to as a “style box”) subdivided into quarters “Q1,” “Q2,” “Q3,” “Q4.” The assets in quarter “Q1” are used to construct a large cap value style index, the assets in quarter “Q2” are used to construct a large cap growth style index, the assets in quarter “Q3” are used to construct a small cap value style index, and the assets in quarter “Q4” are used to construct a small cap growth style index.

While the growth and value style indexes are useful, portfolio managers may follow different investment strategies and consider factors other than those considered when evaluating growth and value. Therefore, a need exists for methods of creating additional style indexes that may be used as benchmarks for evaluating the performance of managers and portfolios. The present application provides these and other advantages as will be apparent from the following detailed description and accompanying figures.

### BRIEF DESCRIPTION OF THE SEVERAL VIEWS OF THE DRAWING(S)

FIG. 1 is an illustration of a style square having a market capitalization (“market cap”) dimension and a valuation dimension.

FIG. 2 is an illustration of a style cube having a market cap dimension, a valuation dimension, and a stability dimension.

FIG. 3 is a graph of relative performance of a defensive style index and a dynamic style index both of which were created from the Russell 1000 index using a method illustrated in FIG. 4.

FIG. 4 is a flow diagram of a method of constructing one or more stability style indexes from a pool of assets (e.g., a parent index).

FIG. 5 is an illustration of stability descriptive variables, price volatility variables, a quality score, a volatility score, and a stability probability score used by the method of FIG. 4.

FIG. 6 is a graph of a non-linear function used to assign scores (e.g., defensive scores or dynamic scores) to each of the stability descriptive variables and price volatility variables illustrated in FIG. 5.

FIG. 7 is a flow diagram of a direct method of constructing one or more combination style indexes.

FIG. 8 is a flow diagram of a style hierarchy method of constructing one or more combination style indexes.

FIG. 9 is a diagram of a hardware environment and an operating environment in which one or more of the methods of FIGS. 4, 7, and 8 may be implemented.

### DETAILED DESCRIPTION OF THE INVENTION

Unless defined otherwise, technical and financial terms used herein have the same meaning as commonly understood by one of ordinary skill in the art to which this invention belongs. For purposes of the present invention, the following terms are defined below.

Alpha: a measure of a portfolio's return in excess of the market return, after both have been adjusted for risk. Alpha is also a measure of a portfolio manager's contribution to performance attributable to security selection. A positive alpha indicates that the portfolio outperformed the market on a risk-adjusted basis, and a negative alpha indicates the portfolio underperformed the market.

Asset Allocation: the apportionment of a fund into one or more asset classes.

Asset: a purchasable tangible or intangible item having economic value. Examples of assets include shares in a mutual fund, equities (shares of a stock), bonds, and the like.

Asset Class: a group of securities that exhibit similar characteristics, behave similarly in the marketplace, and are subject to the same laws and regulations. The three main asset classes are equities (e.g., stocks), fixed-income (e.g., bonds), and cash equivalents (e.g., money market instruments). However, asset classes may include additional types of assets, such as real estate and commodities. Each asset class may reflect different risks, return, or investment characteristics. Further, different asset classes may perform differently in the same market environment.

Co-listing and Cross Listing Security: a security having shares traded on more than one exchange. The exchanges may include one or more domestic exchanges, one or more foreign exchanges, and a combination thereof.

Dual Listing Company: two listed companies under a contractual arrangement that operate as if they were a single economic enterprise, but retain separate legal identities, tax residencies, and stock exchange listings. Dual-listed companies have a different set of shareholders, but share ownership of all business operations. Additionally, shareholders retain existing shares with an economic interest in the combined assets of both companies, and shareholders of each company have equivalent dividend, capital, and voting rights on a per share basis. An example of a dual-listed company is Unilever (UK) and Unilever NV (Netherlands).

Equity: a security representing an ownership interest in a company.

Index Reconstitution: A reevaluation of a market index that involves adding and removing stocks and re-ranking existing stocks so that the index mirrors current market capitalization and style. For example, Russell indexes are well known for their annual reconstitution. To reconstitute the Russell indexes, all publicly traded stocks are ranked by market capitalization. Stocks that are ineligible for inclusion in the indexes are removed and the new indexes are formed.

Issue, Security, Company Relationship: an issue is stock-exchange specific. A security can have multiple issues that trade on different exchanges, while a company can have multiple security classes that are traded as different securities.

Market Capitalization: the number of shares outstanding of a company multiplied by their price per share.

Security: a financial instrument representing financial value. Securities include debt securities (e.g., banknotes, bonds, and debentures), equity securities (e.g., stocks), and derivative contracts.

Generally speaking, investments in assets (e.g., equities) issued by companies may be characterized as being investments in those companies. For ease of illustration, the indexes discussed below will be described as representing investments in assets. Thus, the values of the indexes are derived from those assets. Those of ordinary skill in the art appreciate that indexes may represent investments in only a single asset class (e.g., equities) or multiple asset classes. Further, implementations of the indexes described below may represent investments in only securities. Indexes may also be constructed from assets traded in a single country or region or alternatively, assets traded in multiple countries or regions.

### Introduction

Active managers recognize potential benefits in terms of asset price appreciation (e.g., stock price appreciation) as well as potential negatives associated with risks taken by the companies that issued the assets. For each company, these risks include (1) risks related to balance sheet leverage, (2) risks due to economic cycles and industry/product cycles, and (3) risks related to the durability of its business model. Companies with greater than average exposures to certain risks are categorized as “dynamic,” and companies with less than average exposures to these risks are categorized as “defensive.” Companies categorized as “dynamic” are riskier, but their stock prices tend to increase in price faster than those of more risk averse (or lower-risk) companies (e.g., companies categorized as “defensive”) during periods of rapidly rising markets. The stocks of lower-risk companies categorized as “defensive” tend to outperform less risk averse (or higher risk) companies (e.g., companies categorized as “dynamic”) during weak market environments.

As will be described below, whether an asset (e.g., a stock) is defensive or dynamic may be determined using stability descriptive variables and price volatility variables. Aspects of the present description were developed based on investment manager research and capital market analysis that revealed the importance of these variables in explaining market behavior and returns achieved by investment managers. This analysis involved a historical analysis of market performance over the last 20 years starting in the 1990s. At the start of the 1990s, the economy slowed and the market declined. During that period, money managers who emphasized stocks of companies that were less sensitive to economic cycles performed substantially better than the average money manager. Given the uncertainty surrounding the timing and nature of an eventual recovery, the superior relative performance of this subset of managers made sense. Even among growth managers, there was a substantial difference in performance between managers who used a “quality growth” approach to investing and those who focused more on rapid short-term growth. Investors demonstrated a preference for low-volatility stocks at that time. For at least these reasons, the valuation (growth/value) and market cap dimensions of style did not fully explain or account for differences in manager performance.

The market began to shift in 1991, and in the following two years the market strongly benefited U.S. equity managers whose portfolios were more exposed to dynamic companies that were sensitive to the economy, and had leveraged balance sheets and/or demonstrated rapidly improving margins. In other words, risk was being rewarded during the recovery. Once again, the valuation (growth/value) and market cap dimensions of style did not fully explain differences in manager performance. During this period, managers predisposed to investing in the more cyclical parts of the market did well.

In 1994, the shift in risk preference was stopped by concerns that the Federal Reserve would raise interest rates. However, the market did not experience a major reversal because money managers were convinced a soft landing of the U.S. economy had been achieved.

The environment in the mid to late-1990s was very positive for stock price appreciation, and for several years, most market segments participated in a broad-based rally. There were interruptions for the so-called Asian Contagion, the Long-term Capital Management crisis, and the Russian debt crisis. However, these issues were transitory, and by the end of the decade, investor euphoria around dynamic new Internet-associated companies fueled a dot-com bubble. The Initial public offering (“IPO”) market was red hot. Attractive e-commerce companies did not need to demonstrate a record of consistent profits, returns on capital, or financial discipline to attract investors. Stocks of some previously dominant companies in less-exciting industries were shunned by investors and failed to keep up with the market. By 1999, investors demonstrated a substantial preference for stocks of dynamic companies over stocks of defensive companies.

Then, the dot-corn bubble burst. Concerns about economic slowing led to a bear market starting in 2000. Some unusual aspects of stock performance were noted during the market downturn of 2000-2002. Growth stocks usually outperform value stocks when there is increased concern about economic slowing, which may be the result of a belief that true growth companies can grow without a boost from an economic tailwind. A slowdown in the economy often leads to a widening of valuation spreads between growth stocks and their more economically sensitive value counterparts, due to the scarcity of growth in corporate earnings. When something is expected to be scarce, it usually becomes more valuable. During this period, however, the gap in prices between growth stocks and value stocks was actually contracting.

Anomalies were noted along the capitalization dimension as well. Normally, small cap stocks lag their larger cap counterparts when investor concerns about the economy increase, but small cap stocks were outperforming large cap stocks during this period. Once again, the normal relationships among valuation (growth/value) and market cap dimensions of style did not fully explain differences in manager performance. Volatile stocks that had led the market up were declining quickly, and less-volatile stocks that had been seen as boring were holding up very well. In other words, defensive stocks were winning relative to dynamic stocks.

As the economy rebounded in 2003, risk preference shifted again, and many managers with defensive portfolios complained bitterly about a “junk rally.” They said that quality was being completely ignored by the market. It seemed that the more debt a company had on its balance sheet, the more unpredictable its earnings, and the worse its returns on capital, the better its stock price appreciation in 2003. The market was going up, and prices of the volatile stocks of less-predictable companies were going up even more. In other words, dynamic stocks were winning relative to defensive stocks.

By the latter part of the decade, the economy had expanded substantially, and a housing bubble (inflated by financial leverage and loose lending standards) had formed. Market leadership began to take a more defensive stance as concerns about credit quality and sustainability of earnings came to the forefront. The concerns eventually turned to panic as 2008 progressed and some of the most leveraged businesses failed and had to be bailed out by the U.S. Government. The economy was in freefall. The credit markets dried up. Value stocks had historically been considered safer than growth stocks, but cheap stocks kept getting cheaper, and the value of some went to zero. In many cases, it was clear that accounting-based valuation measures, such as leverage, earnings variability, and return on assets, (which theoretically should provide a foundation or a floor) could not be relied upon. The recession affected all companies, but defensive stocks fared far better than their more dynamic counterparts on a relative basis.

In early 2009, equity markets turned. A powerful market rally, led by companies that were leveraged financially and/or sensitive to the economy, ensued. As is usually the case, value stocks rebounded more strongly than growth stocks near the trough of the recession, but differences in returns among managers within the same style were very significant. Whether a manager had a growth style or a value style seemed to matter less than whether that manager was positioned in defensive stocks or dynamic stocks. At this time, dynamic stocks and the managers who bought them were winning.

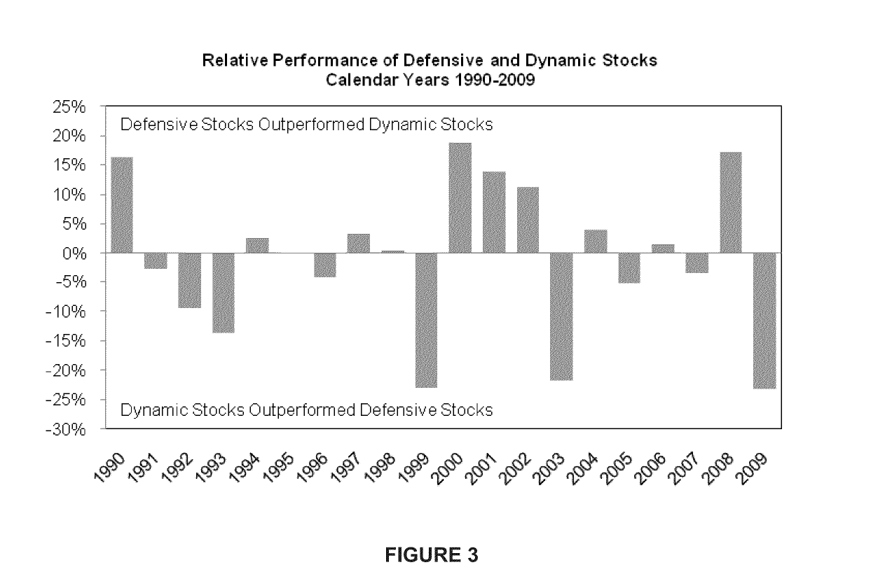

The market events discussed above, which occurred over the last 20 years, illustrate that traditional style benchmarks, namely valuation (growth/value) and market cap (small/large), do not fully explain differences in performance between equity managers. FIG. 3 is a graph of the relative performance of a defensive style index created from the Russell 1000® index using the method described below and a dynamic style index created from the Russell 1000® index using the method described below. The graph demonstrates that the stability descriptive variables and price volatility variables (described below) drove returns during many major market shifts of the past 20 years.

### Constructing Stability Indexes

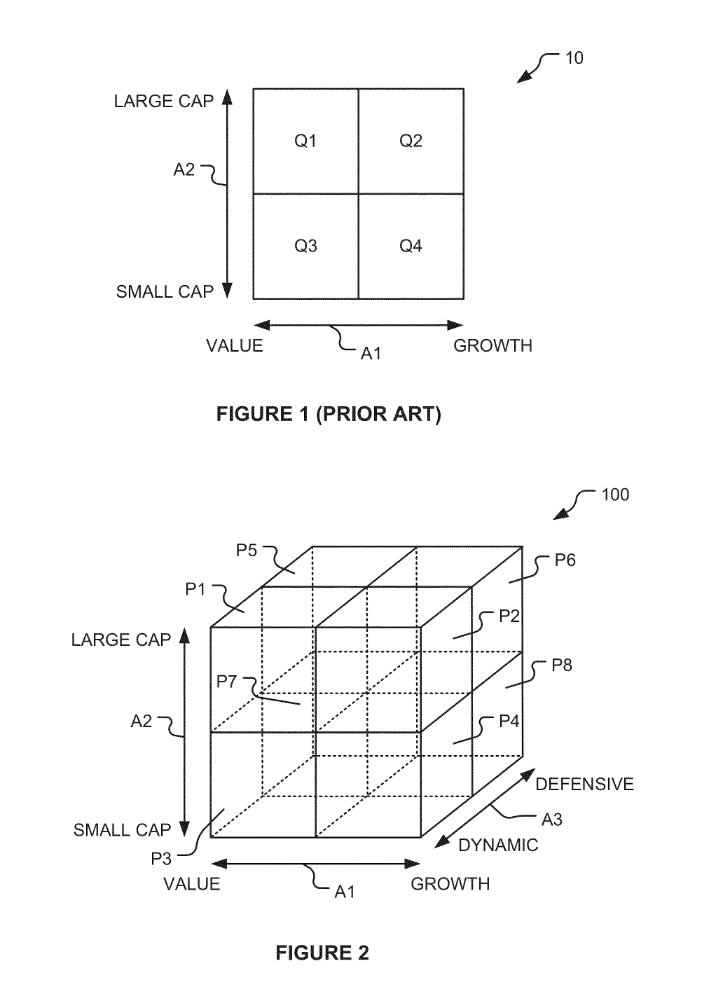

Turning to FIG. 2, the style square 10 illustrated in FIG. 1 may be expanded into a three-dimensional style cube 100 in which the third dimension (identified by double-headed arrow “A3”) is a measure of stability. The third dimension is referred to herein as a “stability dimension.” The stability dimension extends from “dynamic” at one extreme to “defensive” at the other extreme. The three-dimensional cube 100 may be divided into two or more parts (e.g., parts “P1” to “P8”).

Both the valuation dimension (identified by double-headed arrow “A1”) and the stability dimension (identified by double-headed arrow “A3”) are non-size dimensions referred to as style dimensions. In contrast, market cap (identified by double-headed arrow “A2”) is a size dimension. Each of the style dimensions may be divided into two or more styles. For example, the valuation style dimension may be divided into a growth style and a value style. Similarly, the stability style dimension may be divided into a defensive style and a dynamic style.

By way of an example, a dynamic style index may be constructed using the assets in the parts “P1” to “P4,” and a defensive style index may be constructed using the assets in the parts “P5” to “P8.” For example, the dynamic and defensive style indexes may be created by splitting an existing index (e.g., the Russell 1000® Index) in half along the stability dimension. As will be explained below, a separate style index may be constructed using each of the parts “P1” to “P8.”

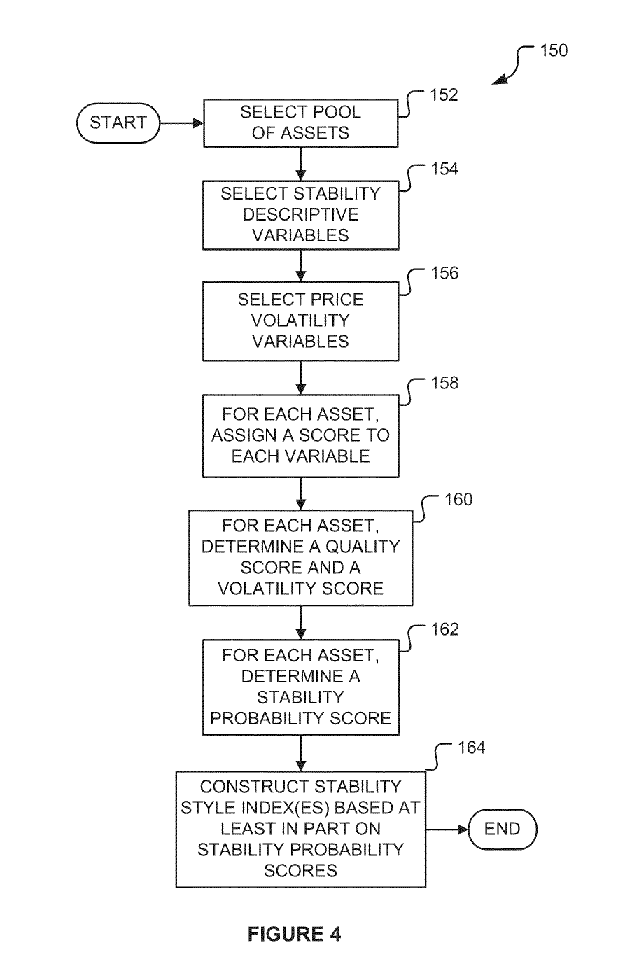

A stability style index may be created using the method 150 illustrated in FIG. 4. In first block 152, a pool of assets (e.g., securities) is selected. The pool of assets may include the assets of an existing index. For example, the Russell 1000® Index, the Russell 2000® Index, or the Russell 3000® Index may be used. However, the method 150 is not limited to use with any particular index. Further, the pool of assets need not include the assets of an existing index.

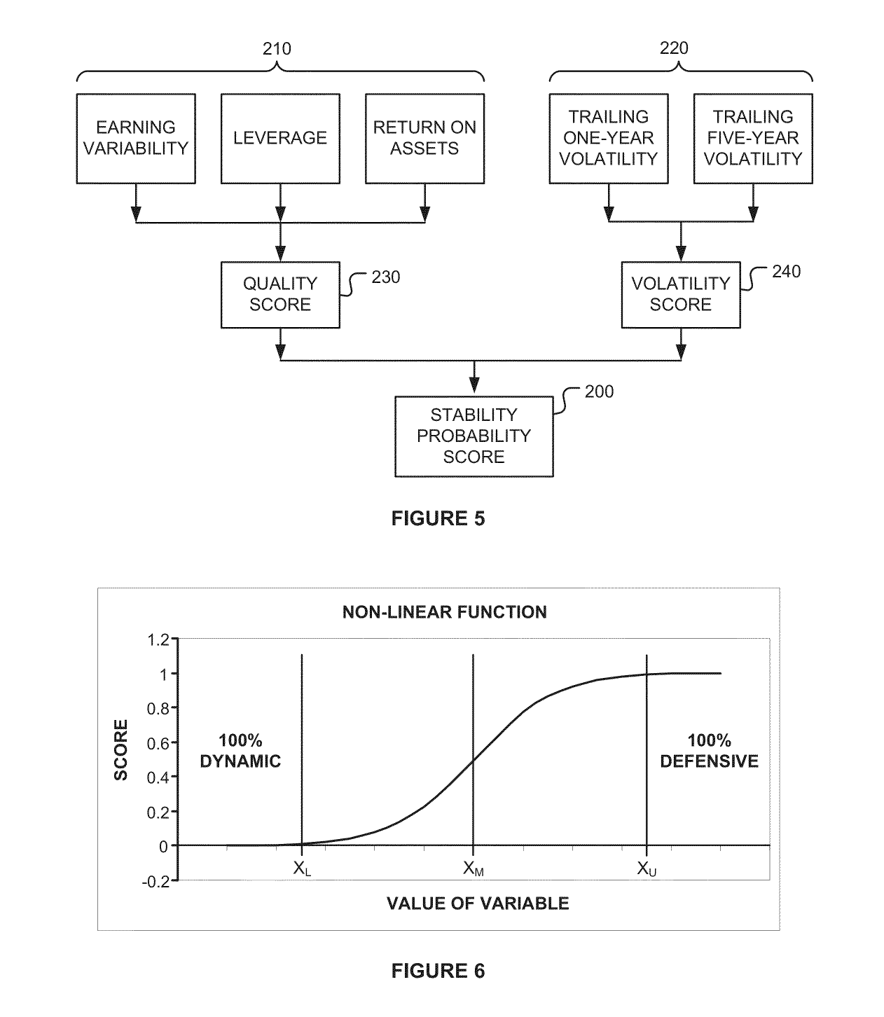

In next block 154, one or more stability descriptive variables 210 (see FIG. 5) are selected. The stability descriptive variables 210 reflect an amount of risk being undertaken by the company. The stability descriptive variables 210 may include one or more variables commonly referred to as accounting variables. By way of a non-limiting example, the stability descriptive variables 210 may include the following:
1. Earnings variability, which functions as a proxy for risks related to economic cycles and industry/product cycles;
2. Debt/equity ratio, which functions as a proxy for balance sheet leverage; and
3. Pre-tax return on assets (“ROA”), which functions as a proxy for the strength of a company's business model.

For a particular asset, earnings variability may be computed on the basis of standard error of a linear earnings per share (“EPS”) trend regression analysis, using earnings data for the company that issued the asset from the past five years. The measure of earnings variability may be scaled by dividing the standard error for the company that issued the asset by its median EPS (over the past five years) to make the company directly comparable to other companies, regardless of the relative level of EPS. Standard error of a linear regression may be used so that if a trend in the EPS occurs overtime, that trend does not contribute to EPS variability. Negative (or zero) EPS numbers are included in the standard error calculation. However, a negative or zero median EPS value is not used to calculate EPS variability. Instead, EPS variability is excluded from the analysis and set to zero (or dynamic). Assigning the value of zero is equivalent to characterizing the company as having very high earnings variability. If fewer than five annual observations of EPS are available, the earnings variability may be considered NULL. For U.S. companies, if there are fewer than 20 observations for EPS (or standard error is equal to zero), the earnings variability is considered NULL and standard error is not calculated. When the earnings variability is considered to be NULL, the earnings variability is treated as a missing variable.

For non-U.S. companies, the debt/equity ratio may be based on the most recent annual report. For U.S. companies, the debt/equity ratio may be based on the most recent quarterly U.S. Securities and Exchange Commission filing. If the debt/equity ratio is negative, the debt/equity ratio may be set to zero (or dynamic).

For non-U.S. companies, the pre-tax ROA may be calculated by dividing annual year-end pre-tax income by an average of the latest year-end and previous year-end assets (e.g., the following formula may be used to calculate pre-tax ROA: (annual year-end pre-tax income/(latest year-end assets+previous year-end assets)/2)). For U.S. companies, the pre-tax ROA may be calculated by dividing the previous year's pre-tax income by an average of the assets for the current and previous years (e.g., the following formula may be used to calculate pre-tax ROA: (previous year's pre-tax income/(current assets+assets for same quarter of the previous year)/2)).

Methods of computing values for the stability descriptive variables identified above are known to those of ordinary skill in the art and will not be described in further detail.

In next block 156, one or more price volatility variables 220 (see FIG. 5) are selected. While the stability descriptive variables 210 (e.g., earnings variability, debt/equity ratio, and ROA) are accounting variables, the price volatility variables 220 are not accounting variables. For a particular asset, the price volatility variables 220 reflect potential market uncertainty about the company that issued the asset. The price volatility variables 220 capture market perceptions of the level of the company's stability, including issues such as litigation risk and regulatory risk that may not be captured fully by the stability descriptive variables 210. By way of a non-limiting example, the price volatility variables 220 may include the following:
1. Trailing one-year volatility, which is a stock's weekly total return volatility over the previous 52 weeks; and
2. Trailing five-year volatility, which is the stock's monthly total return volatility over the previous five years.
   Using the above price volatility variables 220, total return volatility (standard deviation) is measured over two horizons: the previous year, and the previous five years. The trailing one-year volatility may be measured on a weekly basis, using the Friday close as the normal weekly close. The trailing five-year volatility may be based on monthly returns. In this example, when evaluating an asset for May 31, 2011, the trailing five-year volatility may be based on the 60 monthly returns for the period that starts May 31, 2006 and ends May 31, 2011, and the trailing one-year volatility may be based on the 52 weekly returns that end on the last Friday on or before May 31, 2011. In addition to trailing historical volatility, forward looking measures of volatility may be employed, such as commercially available options-implied volatilities. Further, other measures of market risk besides volatility may be employed. These include, for example, value at risk and conditional value at risk measures. Methods of determining values for the price volatility variables identified above are known to those of ordinary skill in the art and will not be described in further detail.

In block 158, a score is assigned to each of the stability descriptive variables 210 (see FIG. 5) and to each of the price volatility variables 220 (see FIG. 5) for each asset in the pool of assets. The score may be within a predetermined range (e.g., zero to one). By way of a non-limiting example, the score may be assigned using a non-linear probability function illustrated in FIG. 6. The term “probability” is used to indicate a degree of certainty that a stock is defensive or dynamic. This method allows stocks to be represented as having both defensive and dynamic characteristics, while preserving the additive nature of the indexes.

For ease of illustration, in block 158, defensive scores are assigned to the stability descriptive variables of the assets. The defensive scores are a measure of defensiveness, or higher relative stability. However, assets are represented by a combination of their defensive and dynamic scores for each stability descriptive variable. For example, if the ROA for an asset is assigned a defensive score of 0.2, the ROA for the same asset is also assigned a dynamic score of 0.8. Together the defensive and dynamic scores fully represent the stability descriptive variable (e.g., ROA) for the asset. In alternate embodiments, the block 158 may be used to assign dynamic scores to the stability descriptive variables of the assets.

To determine the defensive score assigned to a particular stability descriptive variable for each of the assets, the assets are ranked by their values of the particular stability descriptive variable, and the non-linear probability function illustrated in FIG. 6 is applied to the ranked values to assign the defensive score (or weight) to each asset.

In FIG. 6, the quartile breaks are calculated such that approximately 25% of total market capitalization of the assets lies in each quartile. Assets at the median (represented by X_{M}) are divided 50% in each stability style. In other words, assets at the median are assigned a defensive score of 0.5 (which means they also have a dynamic score of 0.5). Assets below the first quartile break (represented by X_{L}) are 100% in the dynamic style. In other words, assets below the first quartile are assigned a defensive score of zero (and have a dynamic score of one). Assets above the third quartile break (represented by X_{U}) are 100% in the defensive style. In other words, assets above the third quartile are assigned a defensive score of one (and have a dynamic score of zero). Assets falling between the first and third quartile breaks are in both dynamic and defensive to varying degrees, depending on how far they are above or below the median and how close they are to the first or third quartile breaks.

The following equations may be used to implement the non-linear function:

$$\begin{matrix}score = 0 & for X < {X}_{L} \\ score = \frac{1}{1 + exp ( \frac{5 ( {X}_{M} - X )}{{X}_{M} - {X}_{L}} )} & for {X}_{L} \geq X < {X}_{M} \\ score = 0.5 & for X = {X}_{M} \\ score = \frac{1}{1 + exp ( \frac{5 ( {X}_{M} - X )}{{X}_{U} - {X}_{M}} )} & for {X}_{M} > X \leq {X}_{U} \\ score = 1 & for X > {X}_{U}\end{matrix}$$

Within the predetermined range, larger values indicate greater stability (and a higher defensive score). Because high leverage and high earnings variability are indicative of low stability (and a lower defensive score), the defensive scores for these stability descriptive variables may be transformed by subtracting their initial value from the maximum score (e.g., one).

If a value is not available for one or more of the stability descriptive variables 210, a predetermined score (e.g., 0.25) may be assigned to each stability descriptive variable for which a value is not available. The predetermined score may be selected to indicate the company's stability is below average. Negative debt/equity ratios may be indicative of instability. Thus, the predetermined score may be assigned to the debt/equity ratio if the debt/equity ratio is negative. Similarly, a negative median EPS may be indicative of instability, and an earnings variability associated with a negative median EPS may be assigned the predetermined score.

For each asset in the pool of assets, each of the price volatility variables 220 (see FIG. 5) is assigned a defensive score within a predetermined range (e.g., zero to one). The defensive score may be assigned using the method described above that assigns defensive scores to the assets for the stability descriptive variables 210. Within the predetermined range, larger values indicate greater volatility. Because high volatility is indicative of low stability (and a lower defensive score), the scores for the price volatility variables 220 may be transformed by subtracting the initial value from the maximum stability score (e.g., one).

If a value is not available for one or more of the volatility variables 220, the predetermined score (e.g., 0.25) may be used for each volatility variable for which a value is not available.

Returning to FIG. 4, in block 160, for each asset in the pool of assets, the defensive scores assigned to the stability descriptive variables 210 are combined into a first score 230, referred to for illustrative purposes as a “quality score,” and the defensive scores assigned to the price volatility variables 220 are combined into a second score 240, referred to for illustrative purposes as a “volatility score.” The defensive scores assigned to each of the stability descriptive variables 210 may be weighted (or scaled) and totaled to obtain the quality score 230. For example, the defensive scores assigned to each of the stability descriptive variables 210 may be multiplied by the inverse of the number of stability descriptive variables 210. Thus, if there are three stability descriptive variables 210, the defensive scores assigned to each of the stability descriptive variables 210 may be multiplied by one third (e.g., approximately 0.33). Then, the weighted (or scaled) scores are totaled to obtain the quality score 230.

In the example illustrated in FIG. 4, the defensive score assigned to the earnings variability is one third of the quality score 230, the defensive score assigned to the debt/equity ratio is one-third of the quality score 230, and the defensive score assigned to the ROA is one-third of the quality score 230. In other words, the defensive score assigned to the earnings variability is multiplied by a first weight, the defensive score assigned to the debt/equity ratio is multiplied by a second weight, and the defensive score assigned to the ROA is multiplied by a third weight with the first, second, and third weights totaling one. Thus, the quality score 230 may be within the predetermined range (e.g., zero to one).

The defensive scores assigned to each of the price volatility variables 220 may be weighted (or scaled) and totaled to obtain the volatility score 240. For example, the defensive scores assigned to each of the price volatility variables 220 may be multiplied by the inverse of the number of price volatility variables 220. Thus, if there are two price volatility variables 220, the defensive scores assigned to each of the price volatility variables 220 may be multiplied by one half (e.g., approximately 0.5). Then, the weighted (or scaled) scores are totaled to obtain the volatility score 240.

For example, the defensive score assigned to the trailing one-year volatility may be half (50%) of the volatility score 240 and the defensive score assigned to the trailing five-year volatility may be half (50%) of the volatility score 240. In other words, the defensive score assigned to the trailing one-year volatility is multiplied by a first weight, and the defensive score assigned to the trailing five-year volatility is multiplied by a second weight with the first and second weights totaling one. Thus, the volatility score 240 may be within the predetermined range (e.g., zero to one).

In block 162, for each asset in the pool of assets, the quality score 230 and the volatility score 240 are combined to obtain a stability probability score 200. The quality score 230 and the volatility score 240 may each be multiplied by a weighting or scaling value (e.g., 0.5) and the weighted scores totaled to obtain the stability probability score 200. For example, the quality score 230 may be 50% of the stability probability score 200 and the volatility score 240 may be 50% of the stability probability score. In other words, the quality score 230 is multiplied by a first weight and the volatility score 240 is multiplied by a second weight with the first and second weights totaling one. Thus, the stability probability score 200 may be within the predetermined range (e.g., zero to one).

IPOs are likely to be missing values for one or more of the descriptive variables 210 and/or the volatility variables 220. When the pool of assets is obtained from an index (e.g., the Russell 1000 index) and an IPO first appears in the index between reconstitution dates, the IPO may be treated as if it's 100% dynamic. Thus, for the assets issued by the IPO, the stability probability score 200 may be assigned a minimum score (e.g., zero) within the predetermined range of scores. At the next reconstitution of the index, a value may be assigned to the stability probability score 200 based on information available at that time.

After a reverse merger of two or more companies, assets issued by the resultant company are assigned the stability probability score of the existing merged company (or companies).

Assets issued by a company “spun-off” from a parent company may be assigned the stability probability score of the assets issued by the parent company. However, it may be useful to set the stability probability score of the assets issued by the spun-off company to be dynamic (e.g., 100% dynamic) when the assets issued by the spun-off company first enter the pool of assets (e.g., the parent index) and for a predetermined time thereafter (e.g., two weeks).

In some implementations, assets issued by some non-U.S. companies and microcap companies may be excluded from the pool of assets. However, non-U.S. companies and microcap companies sometimes merge with non-microcap U.S. companies. When this occurs, the number of shares in the pool of assets (e.g., a parent index) may be updated according to the terms of the merger and the stability probability score left unchanged by the merger.

In the example illustrated, each of the scores (e.g., defensive scores) assigned to the stability descriptive variables 210 and the price volatility variables 220 are within the predetermined range (e.g., zero to one). Further, the quality score 230 and the volatility score 240 are each within the predetermined range, and the stability probability score 200 is within the predetermined range.

In block 164, the stability probability scores assigned to the assets in the pool of assets are used to construct one or more stability style indexes. In block 164, the stability probability score 200 assigned to each asset in the pool of assets is used to categorize the asset (and company that issued the asset) as dynamic, defensive, or a combination thereof. Turning to FIG. 2, after the stability probability scores are assigned to each asset, the cube 100 may be populated using the asset's valuation style score (e.g., growth or value style score), market cap, and stability probability score as coordinates within the three-dimensional axes: valuation (identified by the double-headed arrow “A1”), market cap (identified by the double-headed arrow “A2”), and stability (identified by the double-headed arrow “A3”).

Then, the cube 100 may be used to create a plurality of style indexes. As illustrated in FIG. 1, conventional style indexes typically include one size dimension (e.g., market cap) and one non-size style dimension (e.g., valuation). Typically, the non-size style dimension is valuation, which is used to split a market cap index (such as the Russell® 1000) into growth and value style indexes. However, instead of using valuation as the non-size style dimension, stability may be used in a two-dimensional implementation. In such an implementation, the market cap index may be split into defensive and dynamic style indexes, instead of growth and value style indexes.

As explained above, a style dimension (e.g., the valuation dimension, the stability dimension, and the like) may be divided into two component indexes in which the probabilities assigned to each asset in the two indexes total one. This way, the sum of the number of shares of each asset in the two style indexes equals the number of shares of the asset in the parent index. The number of shares of an asset to be included in a style index may be determined by multiplying the number of shares of the asset in the parent index by the stability probability score 200. For example, if an asset's stability probability score 200 is 0.25 and there are 100 shares of the asset in the parent index, there will be 25 shares in the stability style index. As is apparent to those of ordinary skill in the art, an asset's stability probability score 200 is based on characteristics specific to the company that issued the asset, but may also be affected by the characteristics of other companies in the parent index.

Approximately half the market capitalization of the parent index is assigned to each resulting style index. With respect to each pair of style indexes, assets representing approximately 35% of the market capitalization of the parent index may be assigned entirely to one of the style indexes (i.e., 35% of the market capitalization of the parent index includes assets having style probabilities of one), and assets representing approximately 35% of the market capitalization of the parent index may be assigned entirely to the other style index (i.e., 35% of the market capitalization of the parent index includes assets having style probabilities of zero), leaving assets representing approximately 30% of the market capitalization of the parent index spread across both styles (e.g., defensive and dynamic). Assets having shares on both style indexes have style probabilities greater than zero and less than one.

### Constructing Combination Style Indexes

Style indexes embodying a combination of two or more non-size style dimensions (e.g., valuation and stability) may also be created from a parent index (e.g., a market cap index). For ease of illustration, the parent index will be a market cap index. A style index embodying a combination of two or more non-size style dimensions is referred to herein as a “combination style index.” If one of the non-size style dimensions is stability, the combination style index is also a stability style index. By way of a non-limiting example, the cube 100 illustrated in FIG. 2 may be divided into eight equally sized parts “P1” to “P8” representing the following eight combination style indexes:
1. a large cap value dynamic style index, which includes the assets in part “P1;”
2. a large cap growth dynamic style index, which includes the assets in part “P2;”
3. a small cap value dynamic style index, which includes the assets in part “P3;”
4. a small cap growth dynamic style index, which includes the assets in part “P4;”
5. a large cap value defensive style index, which includes the assets in part “P5;”
6. a large cap growth defensive style index, which includes the assets in part “P6;”
7. a small cap value defensive style index, which includes the assets in part “P7;” and
8. a small cap growth defensive style index, which includes the assets in part “P8.”
   Further, two or more of the parts “P1” to “P8” may be combined to construct combination style indexes.

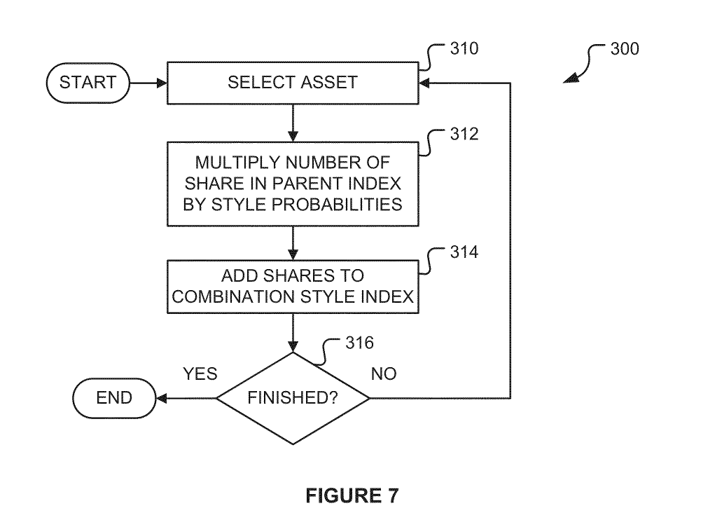

FIG. 7 illustrates a first method 300 (referred to as a “direct method”) of constructing combination style indexes. In block 310, an asset is selected from the parent index. For illustrative purposes, in block 310, asset “A” is selected. Then, in block 312, the number of shares of the selected asset (e.g., the asset “A”) in the parent index are multiplied by the style probability for each style. For example, if asset “A” has a defensive stability probability score of 0.4 and a growth style score of 0.8, the number of shares of asset “A” in a growth defensive style index is the number of shares of the asset in the parent index multiplied by 0.32 (i.e., 0.4*0.8=0.32). Thus, in this example, asset “A” has a dynamic stability probability score of 0.6 and a value style score of 0.2. Therefore, the number of shares of asset “A” in a value dynamic style index is the number of shares of the asset in the parent index multiplied by 0.12 (i.e., 0.6*0.2=0.12). Similarly, the number of shares of asset “A” in a growth dynamic style index is the number of shares of the asset in the parent index multiplied by 0.48 (i.e., 0.6*0.8=0.48), and the number of shares of asset “A” in a value defensive style index is the number of shares of the asset in the parent index multiplied by 0.48 (i.e., 0.4*0.2=0.08). In this example, the sum of the probabilities assigned to a company's stock in each of these four indexes must sum to one. Thus, the sum of shares of the company in each of these four indexes will equal the number of shares of the company in the total index.

In block 314, the number of shares of the selected asset calculated in block 312 is added to the combination style index.

In decision block 316, whether the number of shares to be included in the combination style index has been determined for all of the assets in the parent index is determined. The decision in decision block 316 is “YES” when the number of shares to be included in the combination style index has been determined for all of the assets in the parent index. Otherwise, the decision in decision block 316 is “NO.” When the decision in decision block 316 is “NO,” the method 300 returns to block 310. When the decision in decision block 316 is “YES,” the method 300 terminates.

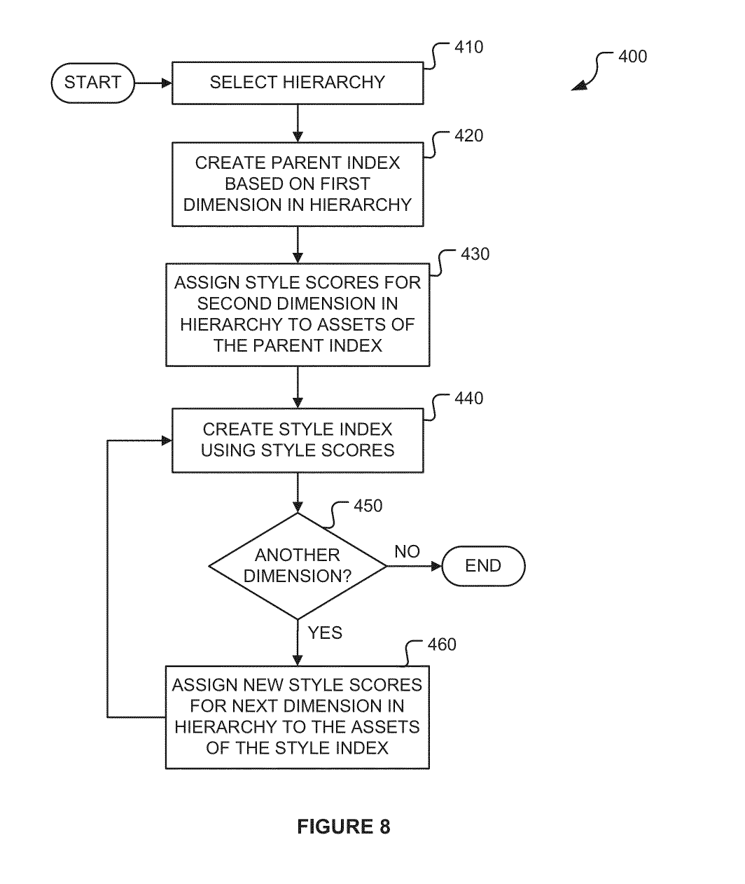

FIG. 8 illustrates a second method 400 (referred to as a “style hierarchy method”) of constructing combination style indexes. A style hierarchy is an ordering of style dimensions. This ordering is used to sequentially construct style dimensions. Some existing style methodologies of constructing style indexes using a single non-size style dimension (e.g., valuation) implicitly use a basic style hierarchy. For example, the hierarchy may be market cap (or size) followed by valuation. In other words, the parent index (e.g., the Russell 3000® index) may be divided into large cap and small cap indexes before valuation is considered. Then, the large cap index may be divided into a large cap growth style index and a large cap value style index and the small cap index divided into a small cap growth style index and a small cap value style index.

Using this approach, to construct the single non-size style dimension indexes (e.g., Growth and Value style indexes), the large cap and small cap indexes are combined. Then, the combined index is divided into the single non-size style dimension indexes. Examples include the Russell 1000 Growth, Russell 1000 Value, Russell 2000 Growth, and Russell 2000 Value Indexes. To further divide the single non-size style dimension indexes into sub-indexes by market cap, assets satisfying the market cap requirements may be selected from the single non-size style dimension index; the number of shares of those assets in the single non-size style dimension index are used to construct the sub-index. For example, a Top 200 Value style index may be created by (1) selecting or creating a Top 200 index (e.g., the Russell Top 200 index) based on market cap, (2) selecting or creating a value style index (e.g., the Russell 1000 Value index), (3) identifying assets in the Top 200 index that are also in the value style index, and (4) assigning the number of shares of the identified assets in the value style index to the Top 200 value style index.

Turning to FIG. 8, the style hierarchy method 400 will now be described. In first block 410, a hierarchy is selected. By way of a non-limiting example, the hierarchy may be size (market cap) followed by a first style dimension followed by a second style dimension. The hierarchy may also be characterized as being a ranking of the dimensions of a multi-dimensional shape (e.g., the square 10 illustrated in FIG. 1, the cube 100 illustrated in FIG. 2, and the like). In next block 420, a parent index is created from a pool of assets based on the first dimension (e.g., size) of the hierarchy. Alternatively, in block 420, the parent index may simply be obtained from a vendor or other third party source. In block 430, style scores (or probabilities) are assigned to the assets of the parent index using the next dimension (e.g., valuation) of the hierarchy. In block 440, a style index (e.g., a growth style index) is created from the parent index. The style index may be created by multiplying the number of shares of each asset in the parent index by the style score assigned to the asset.

In decision block 450, whether the hierarchy includes additional dimensions is determined. The decision in decision block 450 is “YES” when the hierarchy includes additional dimensions. On the other hand, the decision in decision block 450 is “NO” when the hierarchy does not include additional dimensions. When the decision in decision block 450 is “NO,” the method 400 terminates.

When the decision in decision block 450 is “YES,” in block 460, new style scores (or probabilities) are assigned to the assets of the style index created in block 440 using the next dimension (e.g., stability) of the hierarchy. The new style scores will, in general, be different from those that would be obtained by dividing the parent index by the second style dimension (e.g., stability). Then, the method 400 returns to block 440 to create a combination style index (e.g., a growth dynamic style index) using the new style scores (or probabilities). The combination style index may be created by multiplying the number of shares of each asset in the style index (e.g., a growth style index) by the new style score (e.g., a stability probability score) assigned to the asset. Thus, the method 400 may use the new style scores (e.g., stability probability scores) to divide a style index (e.g., a growth style index) into two or more combination style indexes.

The style hierarchy method 400 will now be illustrated by way of an example. In this example, the method 400 is used to create a value-defensive style index. To create this combination style index, the hierarchy selected in block 410 is market cap (or size), followed by valuation, followed by stability. In block 420, a parent market cap index is created (e.g., the Russell 1000 index). In block 430, valuation style scores are assigned to the assets of the parent market cap index. In this example, value style scores may be assigned to the assets of the parent market cap index. In block 440, the number of shares of each asset in the parent market cap index are multiplied by the value style score assigned to the asset to create a value style index. The decision in decision block 450 is “YES” because valuation is not the last dimension in the hierarchy. In block 460, stability probability scores are generated for the assets in the value style index. The stability probability scores may be characterized as being (valuation, stability) probabilities or “valuation-based stability” probabilities. Then, in block 440, the number of shares of each asset in the value style index are multiplied by the stability probability score assigned to the asset to create the value-defensive style index. Thus, the number of shares of an asset in the value-defensive style index is equal to the number of shares of the asset in the value style index multiplied by the stability probability score of the asset. The number of shares of an asset in the value-defensive style index is also equal to the number of shares of the asset in the parent market cap index multiplied by its value style score multiplied by its stability probability score.

While the hierarchy has been described as having the following order: (1) market cap, (2) valuation, and (3) stability, the method 400 is not limited to this order. Alternatively, any order of these three dimensions may be used. Further, one or more dimensions may be repeated in the order.

The style hierarchy method 400 may provide at least one notable advantage. The style hierarchy method 400 may provide a more even division of the market capitalization of the parent index into the combination style indexes. Every time a style split is made by the style algorithm (i.e., the method 400 returns to block 440 from block 460), approximately half of the market capitalization of the previous style index is assigned to each new resulting style index. Thus, the market capitalization of the parent index (created or selected in block 410) may be evenly distributed within a set of combination style indexes created using two, three, four, or more non-size style dimensions.

In contrast, the direct method 300 illustrated in FIG. 7 may produce a more uneven distribution of the market capitalization of the parent index between the combination style indexes. However, if the style dimensions are uncorrelated, the distribution of the market capitalization in the combination style indexes may not be of great concern. Nevertheless, it has been observed that correlations between style dimensions vary over time, can change quickly, and may be considerable in absolute magnitude and can cause an uneven distribution of market capitalization using the direct methodology. When two style dimensions are highly correlated (i.e., companies having certain characteristics with respect to one style dimension also tend to have certain characteristics with respect to a second style dimension), imbalances in the distribution of the market capitalization between the combination style indexes may be correspondingly large. In the case of combination style indexes created using three style dimensions, similar imbalances may be caused by more complex relationships between the three style dimensions. For this reason, it is possible that a combination style index created using the direct method 300 could include no assets in some years.

Nevertheless, depending on the implementation details, approximately half of the market capitalization of the parent index may be assigned to each resulting style index created when block 440 of the method 400 illustrated in FIG. 8 is first performed. While there may be some variation in the exact amount of market capitalization assigned at reconstruction, historically, it has been within a few percentage points. For both product and benchmark purposes, there appear to be compelling reasons to maintain relative stability in the portion of the market capitalization assigned to an index such that it does not vary too dramatically over time.

The stability style indexes (including the combination style indexes created using a stability style dimension) may be configured to be highly diversified, cap-weighted, fully transparent, low-turnover benchmarks. Such benchmarks may be used to help active and passive managers meet client needs and demonstrate that these needs are being met effectively. The stability style indexes offer return patterns that are quite independent and distinct from those of other style indexes.

Low-volatility equity strategies in risk management are currently a hot topic in the industry. A defensive stability style index or combination style index that includes assets issued by defensive companies may be used as benchmark for or to implement low-volatility equity strategies. The reduction in total return volatility (as indicated by a reduction in the standard deviation of total return volatility) available from such an index, relative to traditional equity indexes, can help plan sponsors and other investors achieve their objectives while offering greater downside protection. Defensive style indexes may be used as tools to help active and/or passive managers meet client needs in this regard. Defensive style indexes may provide a consistent and objective reference point that reflects the actual performance of the more stable half of the market. In other words, defensive style indexes may help implement low-volatility equity strategies as an approach to money management or common benchmark for the various defensive (low volatility or high quality) strategies available in the market place.

Although low-volatility strategies have directed significant attention to the more stable parts of the market, the less stable (more dynamic) parts of the market have been largely ignored by investors who study stability-like descriptive variables. However, many active managers seek to produce excess returns by betting on positive changes in companies. Such positive changes are easier to identify in dynamic companies, whether a manager is selecting from among deep-value stocks, where companies may have new management and restructurings, or from among stocks of rapidly growing companies that are launching innovative new products. Such changes tend to be accompanied by stock price volatility. The payoff for being right about a volatile (and therefore at least somewhat dynamic) stock is potentially greater than the payoff for being right about a stable (and therefore at least somewhat defensive) stock. As a result, dynamic style indexes may be better than traditional indexes at reflecting the true habitats of some active money managers. A benchmark that focuses on stocks of dynamic companies may also provide significant alpha opportunity for an active limited long/short manager, which could complement a passive defensive style index. In other words, despite all of the attention that the industry is giving to strategies that emphasize stable stocks, the less stable half of the market may also be represented as part of a comprehensive family of benchmarks.

### Computing Device

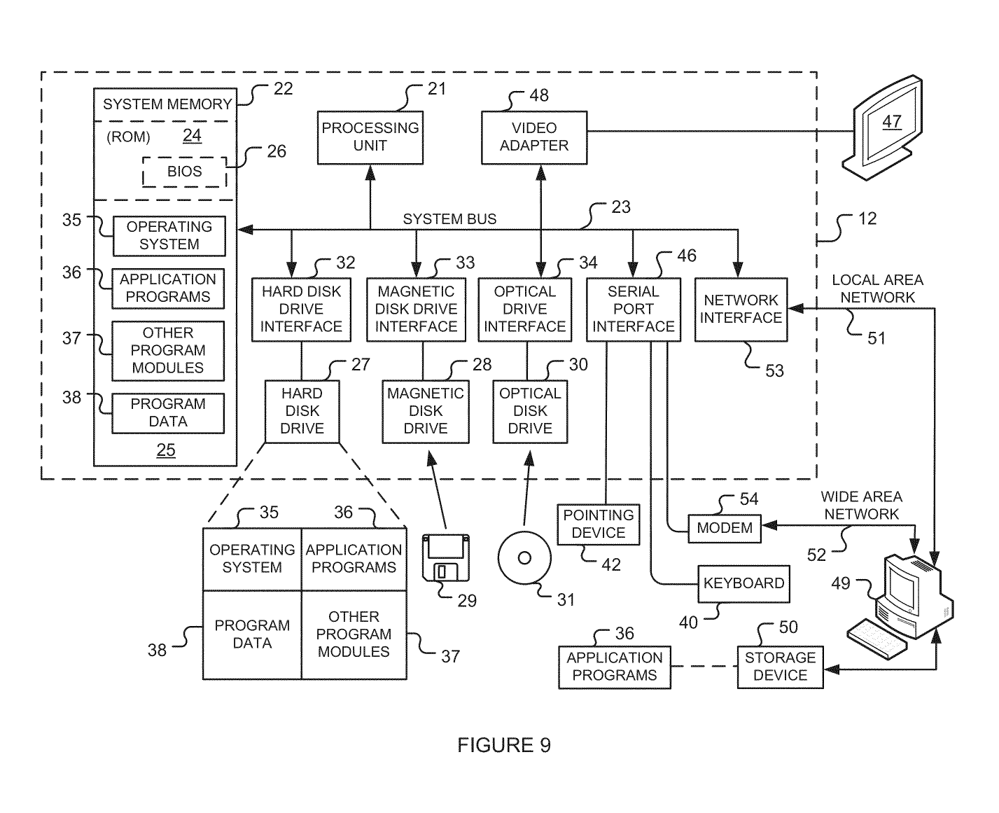

FIG. 9 is a diagram of hardware and an operating environment in conjunction with which implementations of the method 150 (see FIG. 4), the method 300 (see FIG. 7), and the method 400 (see FIG. 8) may be practiced. The description of FIG. 9 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 9 includes a general-purpose computing device in the form of a computing device 12. The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 9 include a local-area network (LAN) 51 and a wide-area network (WAN) 52. Such networking environments are commonplace in offices, enterprise-wide computer networks, intranets and the Internet.

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of the method 150 (see FIG. 4), the method 300 (see FIG. 7), and/or the method 400 (see FIG. 8). Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method of constructing a stability style index from a parent index comprising a plurality of assets, the method comprising:
for each of the plurality of assets, assigning a score to each of one or more stability descriptive variables for the asset based at least in part on a value of the stability descriptive variable;
assigning a quality score to each of the plurality of assets based at least in part on the score assigned to each of the one or more stability descriptive variables for the asset;
for each of the plurality of assets, assigning a score to each of one or more price volatility variables for the asset based at least in part on a value of the price volatility variable;
assigning a volatility score to each of the plurality of assets based at least in part on the score assigned to each of the one or more price volatility variables for the asset;
assigning a stability probability score to each of the plurality of assets as a function of the quality score and the volatility score; and
constructing the stability style index based on the stability probability scores assigned to the plurality of assets.

2. The method of claim 1 for use with the parent index being a style index with each of the plurality of assets having a style score, wherein constructing the stability style index comprises:
for each of the plurality of assets, multiplying a number of shares of the asset in the parent index by both the stability probability score assigned to the asset and the style score assigned to the asset to obtain a number of shares to include in the stability style index.

3. The method of claim 1, wherein constructing the stability style index comprises:
for each of the plurality of assets, multiplying a number of shares of the asset in the parent index by the stability probability score assigned to the asset to obtain a number of shares to include in the stability style index.

4. The method of claim 1, further comprising:
determining the score assigned to each of the one or more stability descriptive variables for each of the plurality of assets,
for each stability descriptive variable, the score being determined by ranking the values of the stability descriptive variable of the plurality of assets and determining the score based at least in part on the ranking.

5. The method of claim 4, wherein the plurality of assets have a total market capitalization; and within the ranking:
a first portion of the plurality of assets having lowest rankings and comprising a first predetermined portion of the total market capitalization are assigned a minimum score,
a second portion of the plurality of assets having the highest rankings and comprising a second predetermined portion of the total market capitalization are assigned a maximum score, and
a non-linear function is used to assign scores to a remaining portion of the plurality of assets based at least in part on their rankings.

6. The method of claim 1, further comprising:
determining the score assigned to each of the one or more price volatility variables for each of the plurality of assets,
for each price volatility variable, the score being determined by ranking the values of the price volatility variable of the plurality of assets and determining the score based at least in part on the ranking.

7. The method of claim 6 for use with a plurality of assets having a total market capitalization wherein within the ranking:
a first portion of the plurality of assets having lowest rankings and comprising a first predetermined portion of the total market capitalization are assigned a minimum score,
a second portion of the plurality of assets having the highest rankings and comprising a second predetermined portion of the total market capitalization are assigned a maximum score, and
a non-linear function is used to assign scores to a remaining portion of the plurality of assets based at least in part on their rankings.

8. The method of claim 1, wherein the one or more stability descriptive variables comprise a plurality of stability descriptive variables having a number of stability descriptive variables, and the method further comprises:
determining the quality score for each of the plurality of assets by totaling products of the score assigned to each of the plurality of stability descriptive variables for the asset and an inverse of the number of stability descriptive variables.

9. The method of claim 8, wherein the one or more price volatility variables comprise a plurality of price volatility variables having a number of price volatility variables, and the method further comprises:
determining the volatility score for each of the plurality of assets by totaling products of the score assigned to each of the plurality of price volatility variables for the asset and an inverse of the number of price volatility variables.

10. The method of claim 9, wherein the stability probability score for each of the plurality of assets is equal to a sum of half of the quality score and half of the volatility score.

11. The method of claim 1, wherein the one or more stability descriptive variables comprise:
an earnings variability variable;
a debt to equity ratio variable; and
a pre-tax return on assets variable.

12. The method of claim 1, wherein the one or more price volatility variables comprise:
a trailing one-year volatility variable; and
a trailing five-year volatility variable.

13. The method of claim 1, wherein for each of the plurality of assets, the score assigned to each of one or more stability descriptive variables, the score assigned to each of one or more price volatility variables, the quality score, the volatility score, and the stability probability score each have a value that is greater than or equal to zero and less than or equal to one.

14. A system for constructing a stability style index from a parent index comprising a plurality of assets, the system comprising one or more computing devices programmed to perform a method individually or in combination with one another, the method comprising:
for each of the plurality of assets, assigning a score to each of one or more stability descriptive variables for the asset based at least in part on a value of the stability descriptive variable;
assigning a quality score to each of the plurality of assets based at least in part on the score assigned to each of the one or more stability descriptive variables for the asset;
for each of the plurality of assets, assigning a score to each of one or more price volatility variables for the asset based at least in part on a value of the price volatility variable;
assigning a volatility score to each of the plurality of assets based at least in part on the score assigned to each of the one or more price volatility variables for the asset;
assigning a stability probability score to each of the plurality of assets as a function of the quality score and the volatility score; and
constructing the stability style index based on the stability probability scores assigned to the plurality of assets.

15. One or more computer-readable medium comprising instructions for constructing a stability style index from a parent index comprising a plurality of assets, the instructions being executable by one or more processors and when executed thereby instructing the one or more processors to perform a method comprising:
for each of the plurality of assets, assigning a score to each of one or more stability descriptive variables for the asset based at least in part on a value of the stability descriptive variable;
assigning a quality score to each of the plurality of assets based at least in part on the score assigned to each of the one or more stability descriptive variables for the asset;
for each of the plurality of assets, assigning a score to each of one or more price volatility variables for the asset based at least in part on a value of the price volatility variable;
assigning a volatility score to each of the plurality of assets based at least in part on the score assigned to each of the one or more price volatility variables for the asset;
assigning a stability probability score to each of the plurality of assets as a function of the quality score and the volatility score; and
constructing the stability style index based on the stability probability scores assigned to the plurality of assets.
